(19) United States
(12) Patent Application Publication
(10) Pub. No.: US 2020/0318429 A1
(43) Pub. Date: Oct. 8, 2020

(54) Decorative garage door screen assembly

(71) Applicant: Michael Heissenberg, Port St. Lucie, FL (US)

(72) Inventor: Michael Heissenberg, Port St. Lucie, FL (US)

(21) Appl. No.: 16/838,636

(22) Filed: Apr. 2, 2020

Related U.S. Application Data
(60) Provisional application No. 62/828,751, filed on Apr. 3, 2019.

(51) Int. Cl. E06B 9/52

(52) U.S. Cl. CPC E06B 9/521

(57) ABSTRACT

A retractable decorative screen door assembly for installation in residential garage door openings for use in creating an appearance of a closed garage door in residential homeowners' associations where regulations and restrictions prohibit the appearance of an open garage door for an extended period of time. The screen is shaded with various patterns to provide the appearance of windows, panels and door frames.

### PRIORITY CLAIM

In accordance with 37 C.F.R. § 1.76, a claim of priority is included in an Application Data Sheet filed concurrently herewith. Accordingly, the present application claims the priority date of U.S. Provisional Patent Application No. 62/828,751 filed Apr. 3, 2019 entitled “DECORATIVE GARAGE DOOR SCREEN ASSEMBLY” the contents of which are incorporated herein by reference.

### FIELD OF THE INVENTION

The present invention relates to a retractable screen door assembly for installation in residential garage door openings for use in creating an appearance of a closed garage door in residential homeowners' associations where regulations and restrictions prohibit the appearance of an open garage door for an extended period of time.

### BACKGROUND OF THE INVENTION

Many homeowners' associations (“HOA's”) are known to maintain regulations enforcing uniform appearance of all residences within the association. Historically, HOA's have disapproved of the appearance of open garage doors on members' residences, so as not to distract from the appearance of the neighborhood. For this reason, HOA's may maintain restrictions wherein homeowners could be cited and fined for leaving their garage doors open for any length of time beyond what it takes to raise and lower the garage door for entry and exit of vehicles.

In many instances, homeowners would benefit from or find it desirable to keep a garage door in an open or raised position for an extended period of time. For instance, the homeowner may find that an open garage door provides ventilation of the home, or is beneficial to keep pets in the garage. Many hobbies, including restoring or repairing and maintaining vehicles, woodworking, painting or other hobbies, may require use of chemicals or paints in an open, ventilated space, such as a garage with an open garage door.

Having a retractable screen enclosure that can be closed while the garage door is in the open position provides ventilaton to the garage and prevents the entry of insects and unwanted animals, as well as leaves and other yard debris which can be blown into the garage by wind. Garage door screens which are currently well know in the art do not obscure Lhe appearance of the contents of the garage and are not sufficient to overcome the restrictions of many homeowners' associations.

### SUMMARY OF THE INVENTION

Disclosed is a vertically extendible and retractable screen door assembly for use in garage openings of residential homes. When the garage door is open, the vertically retractable screen assembly can be lowered into a closed position, with the screen showing a printed image of an actual garage door, making the appearance of the open garage door aesthetically similar to that of a closed garage door. When the retractable screen assembly is in its retracted state, the garage door may be closed.

The assimilated garage door can be used to overcome homeowners' association's restrictions, conceal items within the garage, or simply to disguise that the garage is open. The vertically retractable garage door screen has an image replicating the appearance of an actual garage door printed on the surface of the screen. The shading of the screen can be used to replicate windows and paneling so as to obscure the visibility of the contents of the garage, while creating the appearance of a closed garage door.

An objective of the invention is to provide an aesthetically appealing appearance to a garage opening when a garage door is in the open position and the retractable screen is deployed to keep the appearance uniform with all the other residences in the neighborhood.

Another objective is to provide an enclosed space for recreational or other use, or when a ventilated area is desirable for use when paint or other chemicals may be used, and the homeowners' association would otherwise restrict such use if an appropriate screen is not deployed.

The vertically retractable screen assembly intended for installation at openings for standard 8-foot or 16-foot garage doors.

Other objectives and advantages of this invention will become apparent from the following description, taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a front view of the screen assembly in its extended state, with no graphic screen printed thereon.

FIG. 2 is a front view of the screen assembly in its extended state, with a graphic of a decorative garage door screen printed thereon.

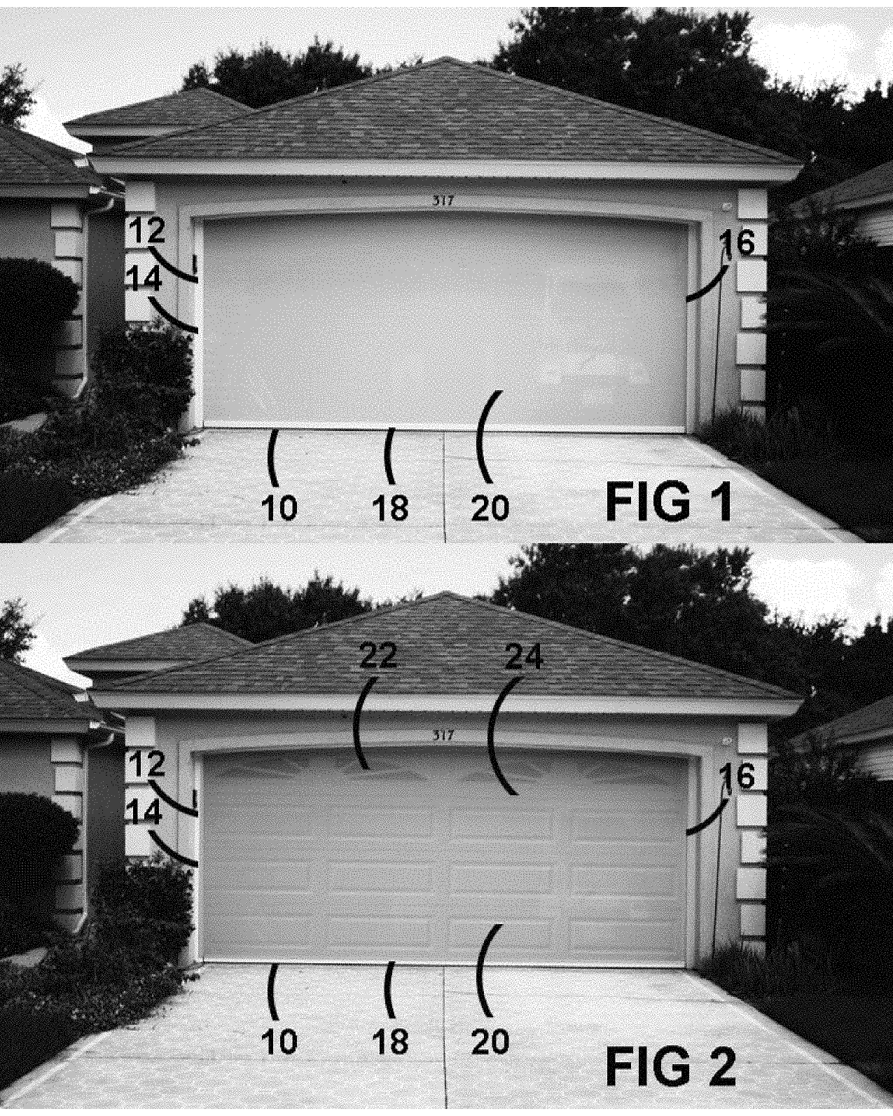

### DESCRIPTION OF THE PREFERRED EMBODIMENT OF THE INVENTION

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Referring to the Figures in general, disclosed is a decorative retractable screen assembly 10 having a frame 12 with flexible aluminum side members 14 and 16 and a horizontally disposed upper roller (not shown) for storage of the screen assembly 10 in a retracted position. A lower fixed member 18, constructed from plastic or aluminum, provides a weight to maintain a flexible screen 20 in a taunt and deployed position.

The retractable screen assembly 10 is mounted on a roller (not shown) which is affixed to the upper inner frame header of the garage door opening 22. In the preferred embodiment, the flexible screen 20 is attached to a frame track fastened to each side of the garage opening. The frame track forms a compartment for receipt of a guide rail positioned within said compartment. The guide rail has a front chamber axially aligned for receipt of a screen having a length configured to be wound onto and deployed from the horizontally disposed rotatable shaft secured to the header. The screen has laterally opposed side edges with an elongated flexible protrusion secured along the length of each side edge. In the preferred embodiment, a decompression gasket formed from rubber is attached to the guide rail and frame track to keep the screen tight between the sides of the garage. Gusts of wind or misalignment of the screen are accommodated by the decompression gasket. The use of guide rails and a biasing means to provide self leveling are detailed in co-pending patent application Ser. No. 62/828,758 the contents of which is incorporated herein by reference.

The flexible screen 20 is preferably imprinted with an image 24 that replicates a garage door. The imprint is constructed and arranged to provide shadows to replicate decorative panel shapes, darkened areas to replicate windows, and shadow lines to replicate spacing between panels. The shadows also serve to obscure the contents of the garage from inquisitive eyes, especially during sunlight hours when the interior of the garage has less light than the surrounding exterior areas.

The garage door screen comprises a single piece of screen material sized to encompass a garage door opening, said screen material having shadows imprinted on one side of said screen material to replicate decorative panel shapes, imprinted darkened areas on one side of said screen material to replicate windows, and imprinted shadow lines on one side of said screen material to replicate spacing between said decorative panel shapes; wherein said imprinting is constructed and arranged to replicate a garage door decorative design and obscure viewing of garage contents.

The method of replicating the garage door having a decorative design comprises the steps of: sizing a single piece of screen material to encompass said garage door opening; imprinting shadows on one side of said screen material to replicate decorative panel shapes; imprinting darkened areas on one side of said screen material to replicate windows; and imprinting shadow lines on one side of said screen material to replicate spacing between said decorative panel shapes; wherein said imprinting is constructed and arranged to replicate said garage door decorative design. The mesh size and imprinting obscures viewing of contents placed with a garage space. The screen material of a mesh size to prevent insects from passing through and allows air to pass.

All patents and publications mentioned in this specification are indicative of the levels of those skilled in the art to which the invention pertains. It is to be understood that while a certain form of the invention illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined the scope of the appended claims. Although the invention has been described in connection with specific preferred embodiments, it should be understood that the invention as claimed should be unduly limited to such specific embodiments. Indeed, various modifications of the described modes for carrying out the invention which are obvious to those skilled in the art are intended to be within the scope of the following, claims.

What is claimed is:

1. A method of replicating a garage door having a decorative design comprising the steps of:
sizing a single piece of screen material to encompass said garage door opening;
imprinting shadows on one side of said screen material to replicate decorative panel shapes;
imprinting darkened areas on one side of said screen material to replicate windows; and
imprinting shadow lines on one side of said screen material to replicate spacing between said decorative panel shapes;
wherein said imprinting is constructed and arranged to replicate said garage door decorative design.

2. The method of replicating a garage door according to claim 1 wherein said mesh size and imprinting obscures viewing of contents placed with a garage space.

3. The method of replicating a garage door according to claim 1 wherein said screen material is of a mesh size to prevent insects from passing through and allows air to pass.

4. A garage door screen comprising: a single piece of screen material sized to encompass a garage door opening, said screen material having shadows imprinted on one side of said screen material to replicate decorative panel shapes, imprinted darkened areas on one side of said screen material to replicate windows, and imprinted shadow lines on one side of said screen material to replicate spacing between said decorative panel shapes; wherein said imprinting is constructed and arranged to replicate a garage door decorative design and obscure viewing of garage contents.
